(19) United States
(12) Patent Application Publication
(10) Pub. No.: US 2018/0189757 A1
(43) Pub. Date: Jul. 5, 2018

(54) System and User Interfaces for Preference Based Micropayment Processing

(71) Applicant: Mitoc Group Inc., Woodcliff Lake, NJ (US)

(72) Inventor: Eugeniu Istrati, Glen Rock, NJ (US)

(73) Assignee: Mitoc Group Inc., Woodcliff Lake, NJ (US)

(21) Appl. No.: 15/393,956

(22) Filed: Dec. 29, 2016

(51) Int. Cl. G06Q 20/12; G06Q 20/38; G06Q 20/40; G06Q 50/00; G06F 3/0482

(52) U.S. Cl. CPC G06Q 20/123; G06Q 20/385; G06F 3/0482; G06Q 50/01; G06Q 20/405

(57) ABSTRACT

A micropayment processing system and method of processing micropayments for media content are described. In one embodiment, the system includes a drop-down widget that is displayed on the display device of a data processing system, wherein the widget is immune to ad blocking. The widget prompts a user to view an advertisement or make a pledge to pay to access media content. The user is permitted to make a predetermined number of pledges via the widget before being prompted to make a payment. The widget provides a pay view that lists acceptable payment methods in the order from the most likely form of payment used by the user to the least likely form of payment used by the user. Upon receiving payment, the widget creates an authentication token that is associated with the chosen payment method that can be reused for future transactions.

### FIELD OF THE INVENTION

The present invention generally relates to online payment transactions. More particularly, the present invention is directed to a system and user interface for prioritizing micropayment methods and increasing security for online payment transactions.

### BACKGROUND OF THE INVENTION

Various means of generating revenues and maintaining revenue streams are utilized by online businesses. Particularly, certain types of businesses, namely, content providers that provide blogs, social networks, news websites, and other types of online media content (e.g., videos, photos, texts, etc.) rely on an advertising revenue model. Existing advertising revenue models, however, are generally not effective and can financially cost content providers because many consumers utilize ad blocking software to avoid viewing advertisements.

Some content providers also utilize a traditional sales model to obtain revenue through subscription fees and on-demand access fees. In this regard, payments for subscriptions or on-demand access are received online via a payment portal. Within the payment portal, the consumer can manually input his or her payment information, and then the payment is authorized and processed. Thus, existing systems and methods for receiving and processing online payments require consumers to manually select payment methods. This can be highly inconvenient and can pose security issues, especially when more than one payment transaction is made as consumers are required to input payment information for each transaction.

In consideration of numerous disadvantages with prior art, an improved system and method that is immune to ad blocking software and that improve user experience and user security while providing a way for a wide variety of online businesses to generate revenue through sales, advertising, or any combination thereof. In this regard, the invention described herein addresses these problems by providing a system and user interface that can display advertisements and that can collect payments or pledges for payments.

### SUMMARY OF THE INVENTION

The following discloses a simplified summary of the specification in order to provide a basic understanding of some aspects of the specification. This summary is not an extensive overview of the specification. It is intended to neither identify key or critical elements of the specification nor delineate the scope of the specification. Its sole purpose is to disclose some concepts of the specification in a simplified form as a prelude to the more detailed description that is disclosed later.

Some embodiments of the present system comprise a memory unit having instructions stored thereon, wherein the memory unit is operatively connected to a processor for executing the instructions to provide a graphical user interface (GUI) including a drop-down widget that is displayed on the web page for receiving and processing online payments. In some embodiments, the drop-down widget is displayed on a website that provides news stories and other media content based on an advertising revenue model. It is contemplated, however, that the widget can be used on desktops, web applications, mobile applications, and the like, depending upon embodiments.

In some embodiments, the drop-down widget prompts a consumer to make a pledge to make a payment at a later time or view an advertisement before accessing or unlocking online media content. Each pledge correlates to a predetermined amount of money or fees. If the consumer pledges to make a payment, the consumer's pledge is recorded and the media content is unlocked to be made accessible. When the consumer makes a predetermined number of pledges, the drop-down widget prompts the consumer to make a payment. In some embodiments, the drop-down widget allows the consumer to request a refund after making a pledge. If the consumer requests a refund, the consumer is credited back the transaction amount or fees.

In some embodiments, the drop-down widget prioritizes a list of acceptable payment methods or gateways. In this regard, the widget utilizes the consumer's geographical location, device or operating system, and content type in order to suggest or recommend one or more acceptable payment gateways or list acceptable payment methods in a preferred order from the most likely used payment method to the least likely used payment method.

In some embodiments, the drop-down widget prompts the consumer to provide feedback and/or share his or her experiences of using the widget on social media. Upon receiving user input to share his or her experiences, the widget directs the consumer to sign into the consumer's social media account. Logging onto the consumer's social media account to share experiences allows the widget to authenticate the consumer and reuse the authentication token during pledging and paying processes. The drop-down widget is further configured to provide icons for receiving 1-click feedback buttons or icons that allow users to share their feedback in order to facilitate the reviewing process.

Additionally, the widget reuses payment gateway's authentication capabilities and social media's authentication capabilities (if used), in order to store only the consumer's metadata, thereby increasing privacy and security. More particularly, the widget stores only the authentication token generated from used payment methods and social media accounts as well as relevant metadata for micropayment user interfaces. The rest of the consumer's private information is stored by payment gateway providers that comply with PII, PCI, and other consumer protection standards.

It is, therefore, an objective of the present invention to provide a system that is compatible with various payment providers and payment gateways and that provides consumers with payment choices in a trustworthy and reliable platform.

It is another objective of the present invention to provide a system that increases security and privacy for online payments by reusing authentication capabilities to store only the authentication token and relevant metadata for micropayment user interfaces.

It is still another objective of the present invention to provide a system that consolidates all payment transactions within a predetermined period of time to group transactions together in an organized manner, thereby reducing transaction fees and increasing efficiency.

It is still another objective of the present invention to provide a system that collects pledges for payment in order to minimize the delay of delivering an electronic content to a consumer.

It is still another objective of the present invention to provide a payment system for maintaining a sustainable revenue stream for many businesses that rely on the advertising revenue model.

It is still another objective of the present invention to provide a system that provides a graphic user interface that includes a drop-down widget that monetizes natively specific audiences in a seamless manner while providing a low barrier of entry.

In the light of the foregoing, these and other objectives are accomplished in accordance with the principles of the present invention, wherein the novelty of the present invention will become apparent from the following detailed description and appended claims.

### BRIEF DESCRIPTION OF THE DRAWINGS

The above and other objects and advantages of the present invention will be apparent upon consideration of the following detailed description, taken in conjunction with the accompanying exemplary drawings, in which like reference characters refer to like parts throughout, and in which:

FIG. 1 shows an exemplary graphical user interface including a drop- down widget is displayed on a web page.

FIG. 2 shows a high-level logical flowchart of a method of operating a data processing system graphical user interface including a drop-down widget in accordance with the present invention.

FIG. 3 shows a detailed flow chart of the pledge view before reaching pledge threshold.

FIGS. 4A through 4D show detailed flow charts of the pay view during and after reaching the pledge threshold.

FIG. 5 shows a detailed flow chart of the refund view.

FIG. 6 shows a detailed flow chart of the ads view.

FIG. 7 is a block diagram showing how payment gateway is determined.

FIG. 8 is a block diagram of a machine in the example form of a computer system within which a set of instructions, for causing the machine to perform any one or more of the methods discussed herein, may be executed.

### DETAILED DESCRIPTION OF THE INVENTION

The present invention is directed towards a system and method for prioritizing micropayment methods and increasing security for online payment transactions. For purposes of clarity, and not by way of limitation, illustrative views of the present system and method are described with references made to the above-identified figures. Various modifications obvious to one skilled in the art are deemed to be within the spirit and scope of the present invention.

As used in this application, the terms “component,” “module,” “system,” “interface,” or the like are generally intended to refer to a computer-related entity, either hardware, software, or a combination of hardware and software. For example, a component can be but is not limited to being, a process running on a processor, an object, and/or a computer. By way of illustration, both an application running on a controller and the controller can be a component. One or more components can reside within a process and/or thread of execution and a component can be localized on one computer and/or distributed between two or more computers. As another example, an interface can include I/O components as well as associated processor, application, and/or API components.

It is to be appreciated that determinations or inferences referenced throughout the subject specification can be practiced through the use of artificial intelligence techniques. In this regard, some portions of the following detailed description are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

Furthermore, the claimed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, or media.

Discussions herein utilizing terms such as, for example, “processing,” “computing,” “calculating,” “determining,” “establishing,” “identifying,” “analyzing,” “checking,” or the like, may refer to operations(s) and/or process(es) of a computer, a computing platform, a computing system, or other electronic computing device, that manipulate and/or transfer data represented as physical (e.g., electronic) quantities within the computer's registers and/or memories into other data similarly represented as physical quantities within the computer's registers and/or memories or other information storage medium that may store instructions to perform operations and/or processes.

Some embodiments of the present invention may include one or more wired or wireless links, may utilize one or more components of wireless communication, may utilize one or more methods or protocols of wireless communication, or the like. Some embodiments may utilize wired communication and/or wireless communication.

Some embodiments may be used in conjunction with various devices and systems, for example, a personal computer (PC), a desktop computer, a mobile computer, a laptop, a tablet computer, a server computer, a handheld device, a personal digital assistant (PDA), a wireless communication device, a smart phone, a non-portable device, a wireless access point (AP), a wired or wireless router, a wired or wireless modem, a wired or wireless network, a local area network (LAN), a wireless LAN (WLAN), the Internet, a metropolitan area network (MAN), a wireless MAN (WMAN), a wide area network (WAN), a wireless WAN (WWAN), a personal area network (PAN), a wireless PAN (WPAN), or networks operating in accordance with existing and/or future versions and/or derivatives of long-term evolution (LTE), a device which incorporates a global positioning system (GPS) receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, or the like.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to disclose concepts in a concrete fashion. As used in this application, the term “or” is intended to mean an inclusive “or” rather than an exclusive “or.” Additionally, the articles “a” and “an” as used in this application and the appended claims should generally be construed to mean “one or more” or “at least one” unless specified otherwise or clear from context to be directed to a singular form.

As used herein, the terms “micropayment(s)” and “payment(s)” may be used interchangeably unless the context clearly indicates otherwise. As used herein, the terms “user(s),” “consumer(s),” and “customer(s)” may be used interchangeably unless the context clearly indicates otherwise. As used herein, the terms “payment gateway,” “payment provider,” and “payment option” may be used interchangeably unless the context clearly indicates otherwise. As used herein, the terms “ad(s),” and “advertisement(s)” may be used interchangeably, unless the context clearly indicates otherwise.

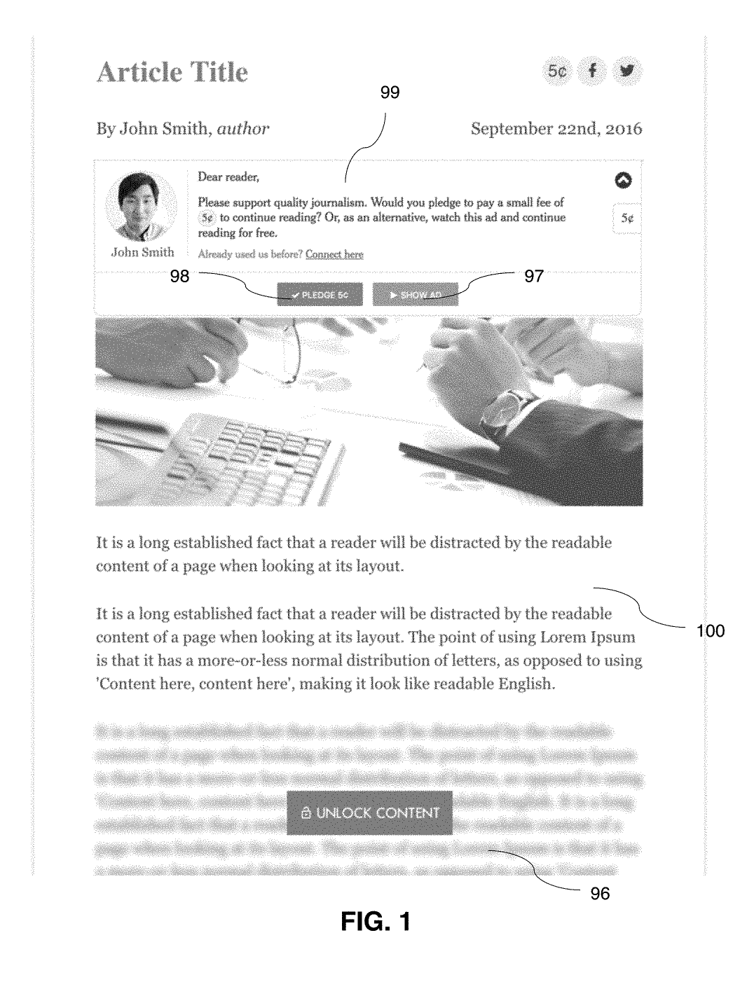

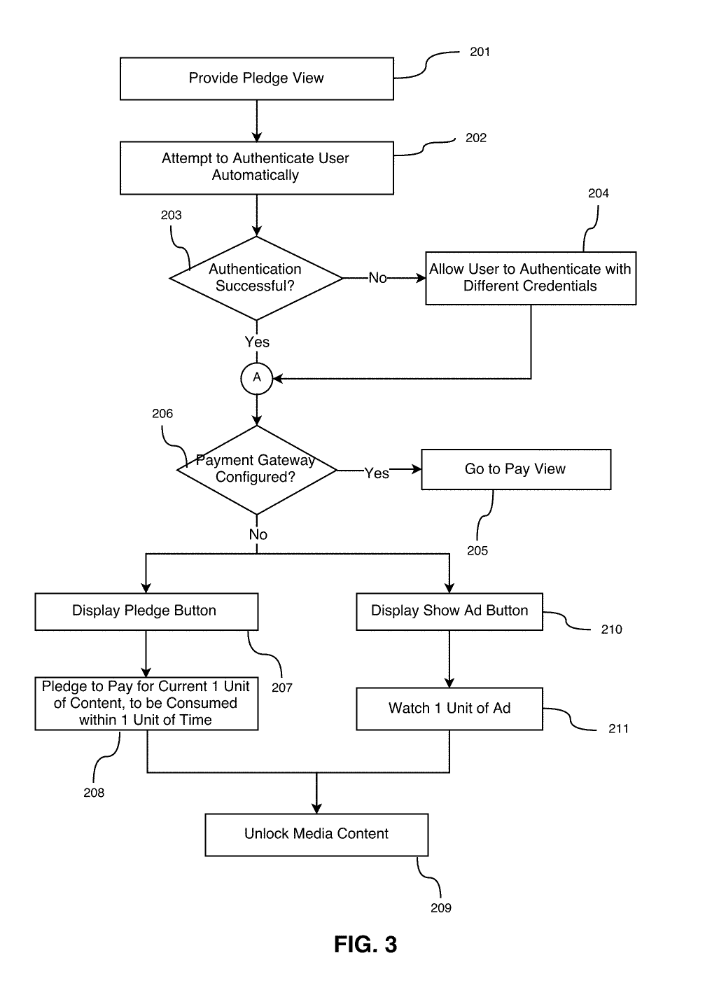

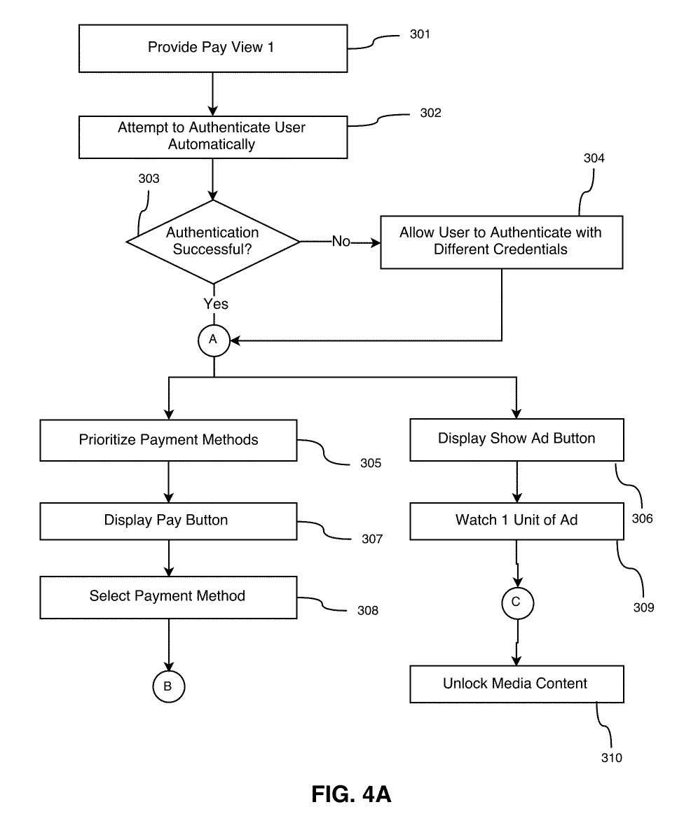

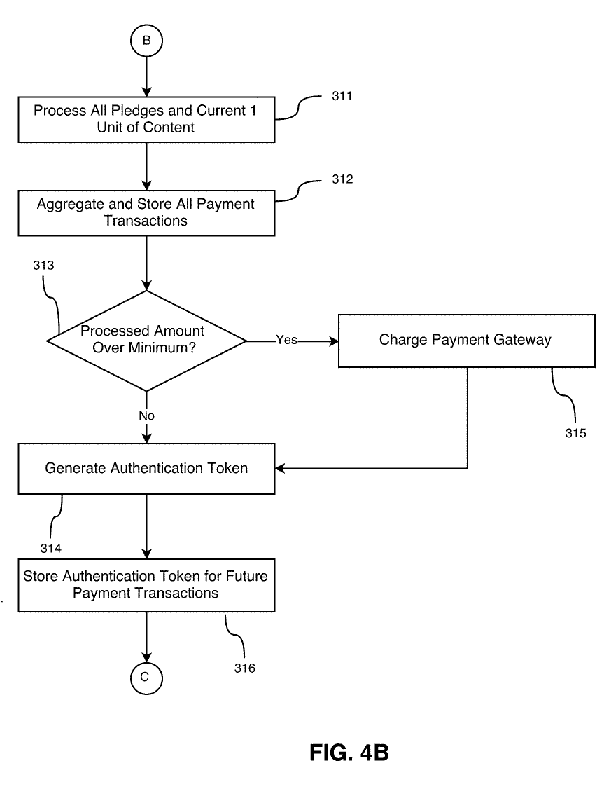

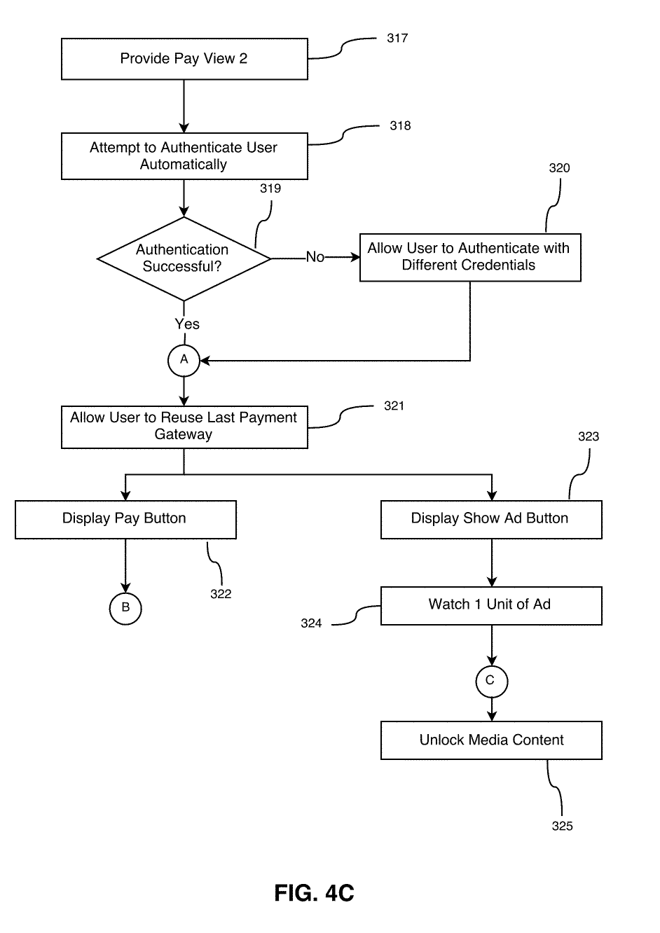

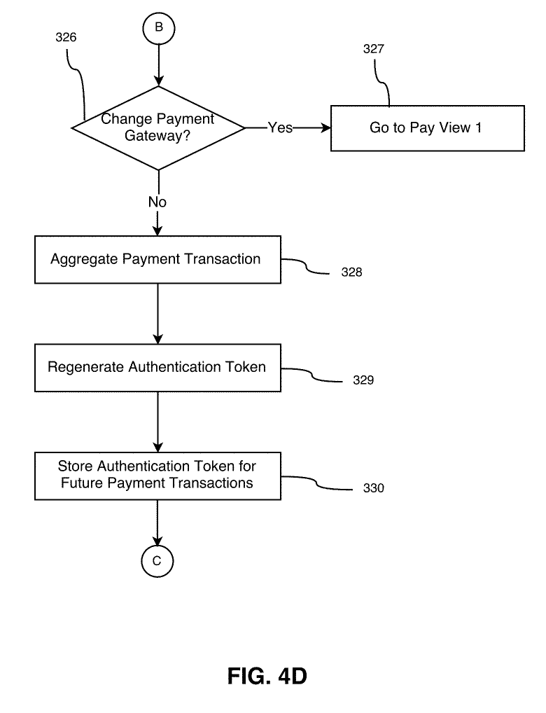

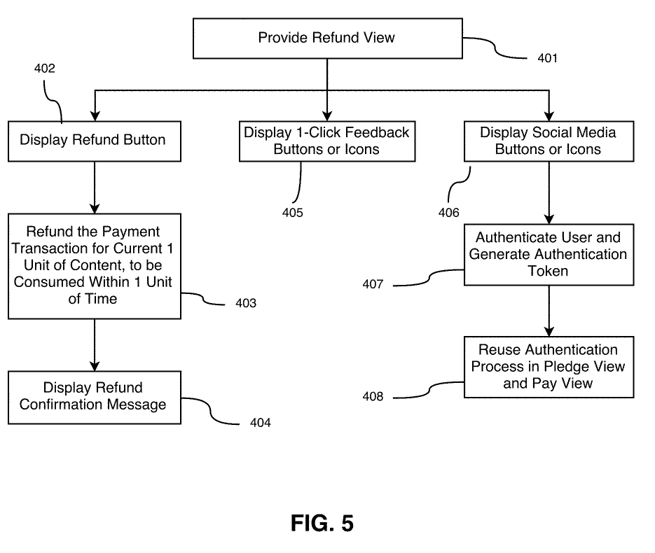

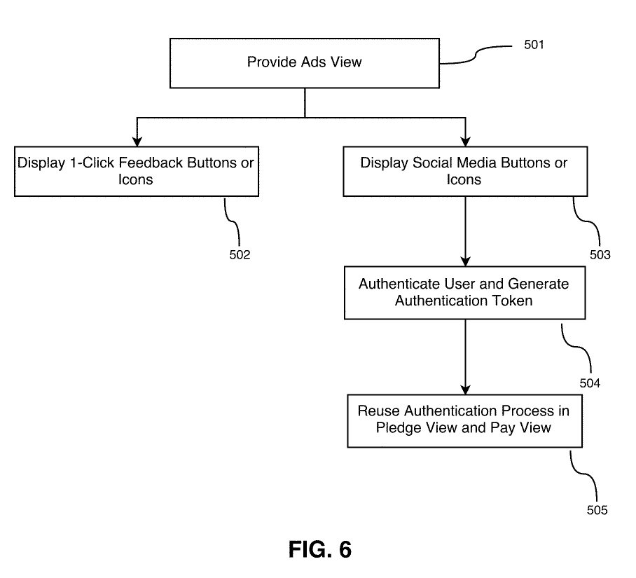

Referring now to FIGS. 1 through 6, there are shown an exemplary graphical user interface including a drop-down widget is displayed on a web page and logical flow charts of a method of operating a data processing system graphical user interface including a drop-down widget in accordance with the present invention. As depicted, the process begins with a user or a consumer 101 accessing a website 100 for an online business that depends on an advertising revenue model. Upon arriving on a web page 100 to access media content, such as an article, video, photos, or any combination thereof, the media content is made obfuscated 96 in whole or in part so that the user cannot access the entire media content.

Additionally, a graphical user interface including a drop-down widget 99 is displayed on the web page 102. The widget 99 is configured to collapse and expand. Without limitation, the drop-down widget 99 is a user-discernable feature of a GUI that may represent, for example, a program, function, action, hardware component, data collection, menu bar item, or user preference. The selections 97, 98 represented in the widget are preferably indicated to the user by a textual or graphical label displayed in or adjacent to the widget 99.

In the illustrated embodiment, the user is given the option to view an advertisement 97 before receiving access to the entire media content or to make pledge 98 to pay to access the media content, wherein each pledge correlates to a predetermined fee or a price. In this regard, the user is not required to make a payment until a predetermined number of pledges have been made or a predetermined threshold is reached. It is noted that pledges are collected from a plurality of media content, and not from a single unit of content.

Before reaching the threshold, the user is directed to a pledge view 103. The drop-down widget provides a pledge view 201. As indicated in block 202, the system attempts to authenticate the user to the website automatically. If the authentication is not successful 203, then the system allows the user to authenticate with different credentials 204. If the authentication is successful 203, the view is personalized with user's metadata. The user is directed to a pay view 205 when the payment gateway is configured and the threshold is reached or after the threshold is reached. If the threshold is not reached and the authentication is completed, and the payment gateway is not configured, the widget displays a pledge button 207 and a show ad button 210. The pledge button can be actuated such that the user can pledge to pay for current one unit of content, to be consumed within one unit of time 208. Said another way, making a pledge unlocks one unit of content 209. In this regard, one unit of content can be a combination of one or more text, images, videos, or other media content. Additionally, one unit of time can be a combination of one or more minutes, hours, or days. If the user does not want to make a pledge, the user can activate the show ad button to watch one unit of advertisement 211, which automatically unlocks one unit of content 209.

When reaching the threshold, the user is directed to a first pay view 104. The drop-down widget provides the first pay view 301. As indicated in block 302, the system attempts to authenticate the user automatically. If the authentication is not successful 303, the system allows the user to authenticate with different credentials 304. If the authentication is successful, the view is personalized with user's metadata. The widget displays a show ad button 306 to allow a user to watch one unit of advertisement 309 and unlock the media content 310 instead of paying. Concurrently, the payment methods are prioritized 305 and the widget is configured to display a pay button 307. The user can select a pay button and then select a payment method 308.

As indicated in block 311, all pledges and current one unit of content are processed. Preferably, payment transactions for all of the pledges are consolidated 312 such that a payment only occurs when the transactions exceed a predetermined threshold or a minimum payment limit 313. Individually, these transactions cannot be processed by payment gateways due to high costs associated with therewith. Additionally, the payment amount in each of these individual transactions is unable to meet the minimum limit per transaction. In this regard, a payment aggregator consolidates all of the user's transactions for micropayments in a given billing period and determines whether the transactions in that billing period exceed the minimum payment limit, depending upon embodiments. If the consolidated transaction amount does not reach the minimum payment limit, no charge occurs in that billing cycle and any transactions that occurred within that billing cycle is passed on to the next billing cycle (e.g., next month). In this regard, all of the transaction information is transmitted to the payment aggregator and the system retains only the metadata. In this way, the present system reduces transaction fees and increases efficiency.

If the payment transactions amount does exceed the minimum limit 313, the system charges the payment gateway 315 all pledges and current one unit of content, to be consumed within one unit of time 310. The system generates an authentication token 314 and the authentication token can be stored for future payment transactions 316.

After reaching the threshold, the user is directed to a second pay view 105. The second pay view reuses the existing payment gateway setup while allowing the user to change the existing payment gateway setup to a different payment gateway setup. As indicated in block 317, the drop-down widget provides the second pay view. As indicated in block 318, the system attempts to authenticate the user automatically. If the authentication is not successful 319, the system allows the user to authenticate with different credentials or set up different payment methods 320. If the authentication is successful, the view is personalized with user's metadata. As indicated in block 321, the system enables the user to reuse a previously used payment gateway. The widget displays a pay button 322 that can be actuated to make a payment, or a user is prompted to change the payment gateway 326. If the user opts to change the payment gateway, the user is directed to the first pay view 327.

If the user does not change the payment gateway, payment transactions for all of the pledges are aggregated 328 and processed in a single transaction. In processing the payment, the system regenerates an authentication token 329 and the authentication token can be stored for future payment transactions 330. Additionally, the widget displays a show ad button 323 so that the user can watch one unit of advertisement 324 to unlock media content 325.

To provide a refund to a pledge or pay action, the user is directed to a refund view 106. The drop-down widget provides the refund view 401. As indicated in block 402, the widget displays a refund button to refund the payment transaction for current one unit of content, to be consumed within one unit of time 403. The widget displays a refund confirmation message 404 when the refund is processed. Additionally, the widget displays 1-click feedback buttons or icons 405 to enable the user to provide a 1-click feedback. In parallel, the widget displays social media buttons or icons 406 to enable the user to share his or her experiences on social media. If the user decides to share his or her experiences, the user is directed to sign into his or her social media account. The system then authenticates user and generates an authentication token 407. The authentication token can be reused in pledge view and pay view 408.

It is noted that every pledge and pay transaction is recorded and maintained, for example, in one or more database in communication with the present system. In this way, the widget is configured to provide appropriate selections to the user. For example, if the user has reached the threshold number of pledges, the widget is configured to display a selection for receiving a refund, paying, or viewing an advertisement, but not a selection for making more pledges.

Additionally, an authentication token is created when the user is authenticated in the pay view and when the user is authenticated via his or her social media account to share his or her experiences. The authentication token associated with the user's payment gateway and the user's social media account are stored and reused for future transactions.

To provide an advertisement, the user is directed to ads view 107. The drop-down widget provides the ads view 501. As indicated in block 502, the widget displays 1-click feedback buttons or icons. Additionally, the widget displays social media buttons or icons 503 to enable the user to share his or her experiences on social media. If the user decides to share his or her experiences, the user is directed to sign into his or her social media account. The system then authenticates user and generates an authentication token 504. The authentication token can be reused in pledge view and pay view 505.

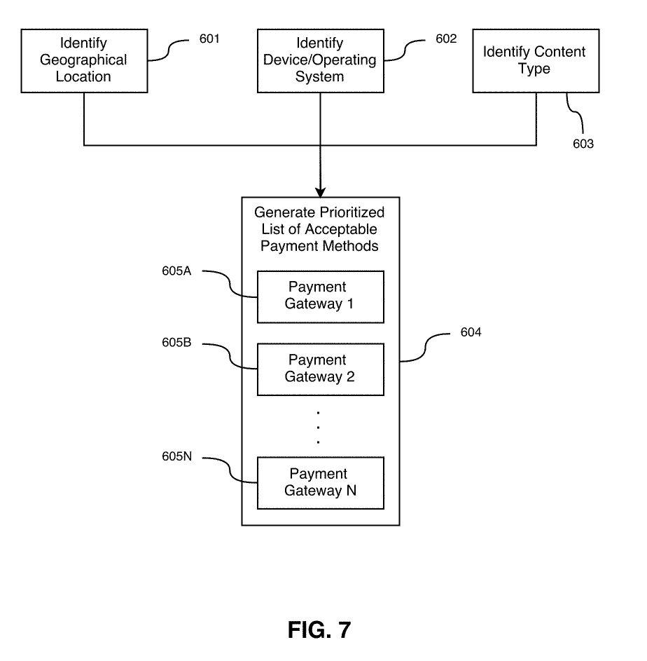

Referring now to FIG. 7, there is shown a block diagram showing how payment gateway is determined. In the illustrated embodiment, geographical location 601 of the user (and hence the user device), device or operating system 602, and content type 603 are considered factors. Non-limiting examples of devices or operating systems 602 comprise iOS®, Android®, Windows®, Linux®, OSX®, or any combination thereof. Additionally, non-limiting examples of media content type 603 comprise articles, texts, images, videos, or any combination thereof.

The aforementioned factors, geographical location 601 (e.g., countries, regions, etc.) device or operating system 602, and content type 603 are combined to generate a prioritized list of the most suitable payment gateways or the payment gateways that the user is most likely to use 604. Preferably, the list comprises at least two payment gateways 605A, 605B. Without limitation, examples of payment options or payment providers comprise Apple Pay®, PayPal®, Stripe®, Android Pay™, Amazon Payments™, various credit cards and cash-based methods, as well as online banking. It is contemplated that the payment providers will provide native authentication methods and authentication credentials.

In operation, if the user is located in the US and is operating an iOS® to access a news article on a news website, the widget lists Apple Pay® as the most preferred method of payment among other types of accepted methods of payment in the pay view. In another example, if the user is located in Italy or Spain and is operating Windows®, PayPal® or Stripe® are listed as the most preferred online payment method while cash-based methods and Apple Pay® are listed towards the bottom of the list.

It is contemplated that the widget matches one or more factors (i.e., geographical location, device or operating system, content type) to an acceptable payment method to determine whether a user is likely to use that payment method. If more factors are matched to a first acceptable payment method compared to a second acceptable payment method, more weight is given to the first acceptable payment method and the first acceptable payment method is listed first.

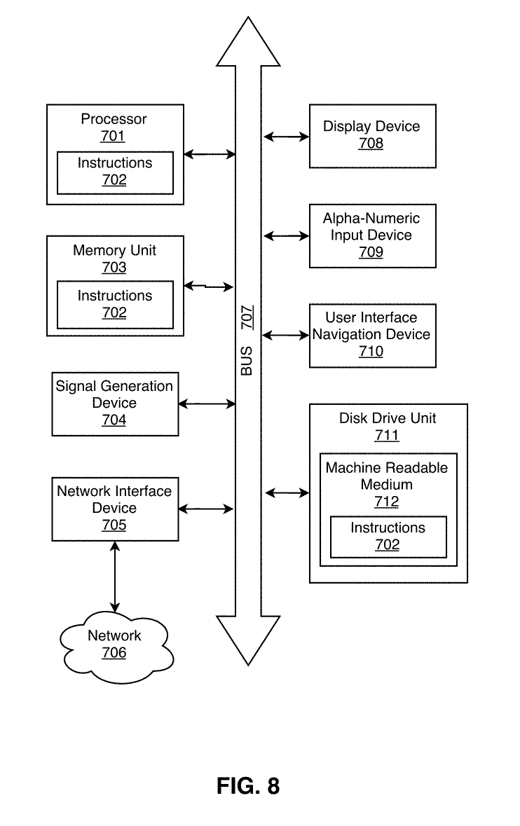

Referring now to FIG. 8, is a block diagram of machine in the example form of a computer system within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system includes a processor 701 (e.g., a central processing unit (CPU), a graphics processing unit (GPU)) and a memory unit 703, which communicate with each other via a bus 707. The computer system may further include a display device 708 (e.g., a liquid crystal display (LCD) or a cathode ray tube (CRT)). The computer system also includes an alphanumeric input device 709 (e.g., a keyboard), a user interface (UI) navigation device 710 (e.g., a mouse), a disk drive unit 711, a signal generation device 704 (e.g., a speaker), and a network interface device 705.

The disk drive unit 711 includes a machine-readable medium 712 on which is stored one or more sets of data structures and instructions 702 (e.g., software) embodying or utilized by any one or more of the methods or functions described herein. The instructions 702 may also reside, completely or at least partially, within the memory unit 703 and/or within the processor 701 during execution thereof by the computer system. In this regard, the memory unit 703 and the processor 701 are also considered machine-readable media.

While the machine-readable medium 712 is shown in an example embodiment to be a single medium, the term “machine-readable medium” may include a single medium or multiple media (e.g., a centralized or distributed database, and/or associated caches and servers) that store the one or more instructions 702 or data structures. The term “non-transitory machine-readable medium” shall also be taken to include any tangible medium that is capable of storing, encoding, or carrying instructions for execution by the machine and that cause the machine to perform any one or more of the methodologies of the present subject matter, or that is capable of storing, encoding, or carrying data structures utilized by or associated with such instructions. The term “non-transitory machine-readable medium” shall accordingly be taken to include, but not be limited to, solid-state memories, and optical and magnetic media. Specific examples of non-transitory machine-readable media include, but are not limited to, non-volatile memory, including by way of example, semiconductor memory devices (e.g., Erasable Programmable Read-Only Memory (EPROM), Electrically Erasable Programmable Read-Only Memory (EEPROM), and flash memory devices), magnetic disks such as internal hard disks and removable disks, magneto-optical disks, and CD-ROM and DVD-ROM disks.

The instructions 702 may further be transmitted or received over a computer network 706 using a transmission medium. The instructions 702 may be transmitted using the network interface device 705 and any one of a number of well-known transfer protocols. The term “transmission medium” shall be taken to include any intangible medium that is capable of storing, encoding, or carrying instructions for execution by the machine, and includes digital or analog communications signals or other intangible media to facilitate communication of such software.

### A Scenario for Operation

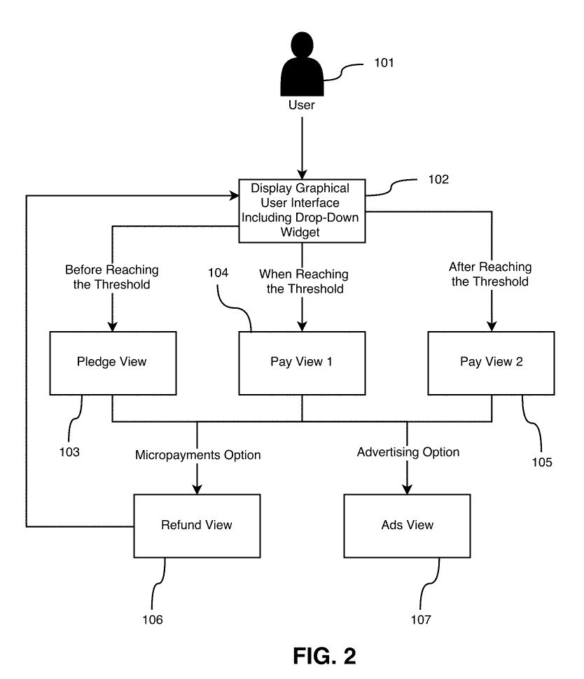

The following list of events may be considered a more concrete example of the functionality of FIGS. 1 through 7 in a realistic scenario involving a consumer on a news website. In this scenario, the functionality of the system, as more generally shown in the flowcharts of FIGS. 2 through 7, is designated by the term “AdTechMedia,” which might be deemed to be the commercial trade name of such a product/service offering. Furthermore, it is noted that one or more steps above may occur in any order of operation.
I. Step 1: A consumer obtains AdTechMedia either as a license or as an online subscription of a web offering such as a website, a web application, and the like.
II. Step 2: The consumer accesses an online newspaper by visiting the newspaper's website.
III. Step 3: A graphical user interface including a drop-down widget is displayed on top of the web page and the media content (e.g., video, article, photos, etc.) on the web page is locked or obfuscated
   a. The consumer makes a pledge, via the widget, to make a payment at a later time to access the media content.
   b. The consumer opts to view an advertisement, via the widget, to access the media content.
IV. Step 4: The media content is unlocked and made accessible to the consumer.
   a. After viewing the media content, the consumer requests a refund and the pledge or payment is credited back to the consumer.
V. Step 5: The consumer makes a predetermined number of pledges and is directed to a pay view.
   a. The consumer's geographical location, device or operating system, and content type are used to recommend at least two payment gateways in order of preference.
   b. An authentication token associated with the consumer's payment gateway is stored and reused for future transactions.
VI. Step 6: The widget prompts the consumer to share his or her experiences on social media.
   a. The consumer logs into his or her social media account.
   b. An authentication token associated with the consumer's social media account is stored and reused for future transactions.
VII. Step 7: The widget prompts the consumer to leave a review.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A machine-implemented method of prioritizing payment methods, comprising the steps of:
displaying a drop-down widget on a website, wherein said website comprises media content, further wherein said media content is locked from accessibility;
collecting a pledge, via said widget;
unlocking said media content to enable accessibility to said media content;
upon receiving a predetermined number of pledges, providing a pay view via said widget, wherein said widget is configured to list acceptable payment methods, further wherein said widget is configured to prioritize said acceptable payment methods in order from the most likely acceptable form of payment to the least likely acceptable form of payment.

2. The method of claim 1, further comprising the steps of:
permitting a selection of one of said acceptable payment methods for a payment transaction;
generating an authentication token associated with a selected payment method;
storing said authentication token for a future payment transaction.

3. The method of claim 2, further comprising the steps of:
determining whether said payment transaction exceeds a minimum payment limit;
if said payment transaction does not exceed said minimum payment limit, aggregating said payment transaction with said future payment transaction.

4. The method of claim 1, further comprising the steps of:
establishing a connection to a social media account associated with a user;
generating an authentication token associated with said social media account;
storing said authentication token.

5. The method of claim 1, further comprising the steps of:
identifying a geographical location of a user that made said pledge via said widget on said website;
identifying a device or operating system operated by said user to make said pledge;
identifying a type of said media content on said website;
determining said acceptable payment methods corresponding to one or more factors, wherein said factors comprise said geographical location, said device or operating system and said type of said media content.

6. The method of claim 5, wherein said acceptable payment methods comprise a first acceptable payment method and a second acceptable payment method;
if a number of said factors corresponding to said first acceptable payment method is greater than a number of said factors corresponding to said second acceptable payment method, listing said first acceptable payment method before said second acceptable payment method.

7. The method of claim 1, further comprising the steps of refunding said pledge after unlocking said media content.

8. A system for prioritizing payment methods, comprising:
a processor and a memory to which said processor is operatively coupled, said memory having executable instructions stored thereon which, when executed, cause said processor to:
obtain a pledge via a drop-down widget on a website specifically for a media content provider, wherein said website comprises media content that is locked from accessibility, further wherein said media content is unlocked after obtaining said pledge;
identify a geographical location of a user that made said pledge via said widget on said web site;
identify a device or operating system operated by said user to make said pledge;
identify a type of said media content on said website;
upon receiving a predetermined number of pledges, determine one or more acceptable payment methods corresponding to one or more factors, wherein said factors comprise said geographical location, said device or operating system, and said type of said media content;
generate a list of said acceptable payment methods, wherein said list is in order from the most likely acceptable form of payment to the least likely acceptable form of payment.

9. The system of claim 8, wherein said processor is further configured to:
permit one of said acceptable payment methods to be selected from said list for a payment transaction;
in response to a selection of one of said acceptable payment methods, generate an authentication token associated with a selected payment method;
store said authentication token for a future payment transaction.

10. The system of claim 9, wherein said processor is further configured to:
determine whether said payment transaction exceeds a minimum payment limit;
if said payment transaction does not exceed said minimum payment limit, aggregating said payment transaction with said future payment transaction.

11. The system of claim 8, wherein said processor is further configured to:
establish a connection to a social media account associated with a user;
generate an authentication token associated with said social media account;
storing said authentication token.

12. The system of claim 8, wherein said acceptable payment methods comprise a first acceptable payment method and a second acceptable payment method;
if a number of said factors corresponding to said first acceptable payment method is greater than a number of said factors corresponding to said second acceptable payment method, listing said first acceptable payment method before said second acceptable payment method.

13. The system of claim 8, wherein said processor is further configured to refund said pledge after unlocking said media content.
